(19) United States
(12) Patent Application Publication
(10) Pub. No.: US 2005/0139309 A1
(43) Pub. Date: Jun. 30, 2005

(54) Method, apparatus and adhesive composition for ophthalmic lens blocking

(76) Inventors: Marc Savoie, Moncton (CA); Adrian Culf, Moncton (CA)

Correspondence Address: FENWICK & WEST LLP, SILICON VALLEY CENTER, 801 CALIFORNIA STREET, MOUNTAIN VIEW, CA, 94041, US

(21) Appl. No.: 10/488,062

(22) PCT Filed: Aug. 26, 2002
(86) PCT No.: PCT/CA02/01302

(30) Foreign Application Priority Data
Aug. 31, 2001 (CA) 2,356,579

(51) Int. Cl. G02B 1/00; G02C 7/00

(52) U.S. Cl. 156/99

(57) ABSTRACT

A method is provided for blocking a lens according to which a lens block is obtained which transmits UV and visible light. An adhesive curable by light within the UV and visible spectrum is applied between the lens blank and a lens mounting face of the lens block. The lens blank is placed adjacent the lens block with the adhesive extending therebetween. UV light is applied to cure the adhesive. The adhesive is selected to have a suitable low dimensional change on setting so as not to impart any undue stresses on the lens blank which being capable of total adhesive failure without lens damage or leaving a residue upon application of a suitable stripping force.

### FIELD OF THE INVENTION

The present invention relates to the bonding of an ophthalmic lens blank to a lens support block (“lens block”) for supporting the lens blank during a lens generating process. More particularly the present invention relates to the use of an adhesive which is curable by light in the ultraviolet (“UV”) and high visible spectrum as a bonding agent.

### BACKGROUND OF THE INVENTION

An ophthalmic lens blank generally has a first face with a predetermined curvature and a second face, opposite the first face on which a desired surface contour is generated by a machining process. The overall process is generally referred to as “lens generation” and the overall object is to yield a finished lens wherein the first and second face curvatures cooperate to yield desired optical properties.

Lens surfacing is carried out using profiling machines which typically have a cutter of some type which is moved across the second face. The lens blank may be stationary or rotating during the cutting operation, depending on the particular profiling machine which is being used.

In order to support the lens blank during profiling, it is bonded to a lens support. The support is grasped by chuck or other suitable coupling means during lens generation to provide secure mounting to the profiling machine while avoiding damage to the lens.

In order to produce a finished lens of the highest possible quality, the position and orientation of the second face relative to the first face must be accurate. As the lens is generally held by the first face during machining, accurate knowledge as to the first face geometry as well as its orientation and position is crucial to the surfacing of the second face if the second face is to be accurately disposed relative to the first face.

U.S. Pat. No. 5,919,080 teaches an apparatus which maps the front face surface, accurately mounts the lens to a lens block and references the contour of the mapped surface to a reference datum on the lens block thereby allowing accurate second face generation by eliminating potential errors arising from inaccurate placement and orientation of the first face during the lens generation operation.

The bonding agent taught by U.S. Pat. No. 5,919,080 is wax, which is injected in a molten state through the lens block between the lens block and the lens blank. The wax is allowed to solidify and adhesively bonds the lens blank to lens block.

It has been found that the use of molten wax as a bonding agent carries certain disadvantages. The wax can cause contamination of the lens, the heat associated with the wax may cause distortion problems with the lens, the wax itself tends to be rather messy and the time required for setting is quite significant, on the order of 15 minutes, before the lens can be safely released to subsequent processing operations.

Other bonding agents, such as curable adhesives have been proposed for bonding a lens to a lens block however these generally present their own disadvantages.

U.S. Pat. No. 5,380,387 teaches a UV or visible light curable adhesive formulation. The formulation however has a significant amount of shrinkage requiring relatively slow curing times so as not to impart undue stresses on the lens which may cause lens deflection and subsequent optical errors. Furthermore in order to de-block the lens, a releasing agent is incorporated which requires immersion in a solvent for de-blocking. The de-blocking procedure is relatively slow with de-blocking times on the order of 30 minutes being suggested. Short de-blocking times require minimal contact with the lens block and all the examples in the patent relate to blocking onto an annular ring. An annular ring may be suitable for glass lenses due to the relatively high structural rigidity of a glass, however machining forces on a plastic lens blank (which represents approximately 90% of the market) requires support underneath the lens during machining to avoid deflection of the lens by the tool used to generate the lens surface. The use of the compounds taught by this patent would be prohibitively slow in de-blocking were a bond to be effected over the entire lens surface. Many of the formulations taught use water as the de-blocking solvent which may not be desirable where water-based lubricants are used in the surfacing operation.

U.S. Pat. No. 5,624,521 teaches the application of a UV cement in dots to promote de-bonding (or de-blocking) by minimizing the surface covered by the UV cement and maximizing the exposed edges available for absorbing a de-blocking solution. Even so, de-blocking times on the order of 1-2 hours are suggested. Furthermore the use of dots does not provide the degree of support that will be provided by an even layer of UV cement between the lens and the lens block. Also a sealant around the edges of the dots is suggested to avoid de-bonding by lubricants used in the lens generation operation.

Both of the above patents teach at least initial hardening by transmitting electromagnetic radiation in the UV spectrum through the lens itself. This may be problematic in cases where a lens is to be blocked which has poor UV transmitting properties such as a UV blocking lens. U.S. Pat. No. 5,007,975 however teaches a method of blocking a lens blank to a lens supporting member with a UV curable adhesive wherein the UV exposure of the adhesive may be effected from either side of the lens block or from the side of the support member. Nevertheless the UV cement taught requires a suitable alkaline or acid aqueous solution. Although UV exposure tines and de-bonding times on the order of 5 seconds to 10 minutes are referred to, the examples typically use exposure times of at least 30 seconds and de-bonding times of at least 3 minutes. The patent addresses very small lenses (non-water swellable contact lenses) and the de-blocking times should be considered in that context. Furthermore, no apparatus is taught for how accurate blocking may be carried out.

All the above references teach the use of high pressure mercury lamps as the source of UV rays. Such lamps generally operate at high temperatures (800°-900° C.) are filled with a toxic substance (mercury), generate a relatively narrow wavelength spectrum and are limited in intensity by the maximum continual power that can be sustained therethrough.

It is an object of the present invention to provide a lens blocking method and apparatus which enables accurate orientation and blocking of a lens blank to a lens block using a UV curable adhesive.

It is a further object of the present invention to provide such a lens blocking apparatus and method which will result in accurate orientation and placement of the lens relative to the lens block and the ability to generate and store first face contour information relative to a datum on the lens block.

It is a still further object of the present invention to provide a lens blocking adhesive curable by light in the UV visible spectrum which may be applied over the majority of a first face surface of the lens, has a viscosity which will prevent its spillage during blocking, has low irritability, is non-hazardous (thereby easing shipping and disposal requirements), is relatively inexpensive, provides adequate support to the lens to avoid optical defects associated with lens flexing during lens generation, is flexible enough to attenuate vibration to avoid de-blocking during generation, is not subject to excessive dimensional change upon curing to avoid lens warpage through shrinkage stresses and is removable without damage or residue using mechanical separation means (i.e. exhibits total adhesive failure as required), sets relatively quickly and does not deform under heat which may be associated with lens manufacture such as in curing lens coatings.

It is yet another object of the present invention to provide a method of bonding a lens to a lens block which allows for the determination of the amount of adhesive required and thereby allows for automatic dispensing of the adhesive without operator intervention.

### SUMMARY OF THE INVENTION

A method of blocking a lens comprising the steps of:
(i) obtaining a lens block which transmits UV and visible light;
(ii) applying an adhesive curable by light within the UV and visible spectrum to at least one of a first face of a lens blank and a lens mounting face of the lens block;
(iii) causing relative movement between the lens blank and the lens block toward each other with the first face of the lens blank facing the lens mounting face and a second face, opposite the first face facing away from the lens mounting face;
(iv) generating light including light within the UV spectrum and transmitting the light to the adhesive through the lens block, the light being of a wavelength and an intensity and applied for a time interval sufficient to cause setting of the adhesive; and
(v) the adhesive being selected to have a dimensional change on setting low enough to be capable of setting in less than 30 seconds without imparting undue stresses on the lens blank and capable of total adhesive failure without lens or lens blank damage or leaving residue on the lens upon application of a sufficient stripping force acting between the lens blank and the lens block.

Preferably the lens block is oriented with the mounting face substantially horizontal during steps (i), (iii) and (iv) and the lens blank is maintained at a predetermined orientation relative to the lens block during steps (iii) and (iv).

More preferably the contour of the first face may be determined prior to step (iii) and the first face may be maintained at a predetermined spaced-apart distance from the lens mounting face during step (iv).

More specifically, a method is provided for blocking a lens comprising the steps of:
(i) placing a lens blank on a lens orienting station;
(ii) determining lens orientation and position parameters;
(iii) transporting the lens blank to a probing station while maintaining the orientation from step (ii);
(iv) mapping a first face contour of the lens blank while maintaining the orientation and generating and storing surface contour data;
(v) installing a lens block in a lens blocking station to expose a lens mounting face of the block, the block being of a light transmissive nature capable of transmitting light within the UV and visible spectrum;
(vi) applying an adhesive curable by light within the UV and visible spectrum to at least one of the lens mounting face and the first face of the lens blank;
(vii) transporting the lens blank to the lens blocking station and positioning the lens blank adjacent the lens mounting face with the first face facing the lens mounting face while maintaining the orientation;
(viii) moving the lens blank toward the lens mounting face until the first face is a predetermined distance from the lens mounting face;
(ix) transmitting UV and visible light through the lens block at a wavelength and an intensity and for a duration sufficient to cause the adhesive to cure thereby bonding the lens blank to the lens block;
(x) referencing the first face surface contour data to a datum associated with the lens block; and
(xi) removing the lens block with the lens blank attached thereto from the blocking station.

Step (ii) above may be carried out by:
(a) generating a desired lens blank position and orientation image on a screen;
(b) generating an image on the screen depicting the orientation of the lens blank on the lens orienting station; and,
(c) positioning and orienting the lens blank to cause the image in step (b) to correspond to the image in step (a).

Alternatively, the lens orientation and position parameters in step (ii) may be determined using computer image recognition of a camera image of the lens without depicting any images on a screen.

Preferably the lens blocking process will include the further steps of determining the position of a second face of the lens opposite the first face and referencing the position of the second face relative to the datum on the lens block.

The adhesive should be selected to be capable of total adhesive failure without lens or lens block damage or leaving residue on the lens upon application of a sufficient stripping force acting between the lens and the lens block.

An apparatus is provided for blocking on ophthalmic lens blank. The apparatus includes a lens blank receiving station for receiving the lens blank and a lens blocking station having a lens block support for receiving a UV and visible light transmissive lens block and supporting the lens block in a desired orientation. The apparatus further has a lens transporter with a lens holder for selectively picking up and holding the lens blank, moving the lens blank to adjacent the lens block support and moving the lens blank toward the lens block support.

A light source capable of emitting light within at least the UV spectrum is associated with the lens block support for emitting such light and directing the light through the lens block. A light source actuator is connected to the light source to control activation and de-activation of the light source. An adhesive dispenser is associated with the lens blocking station for dispensing a UV and light curable adhesive for bonding a lens blank to the lens mounting face. A dispenser actuator is connected to the dispenser for causing the dispenser to dispense the adhesive. A controller communicates with the transporter, the light source actuator and the dispenser actuator to control the operation thereof.

Preferably the dispenser includes a dispenser nozzle and a nozzle manipulator connected thereto for moving the nozzle between a deployed position adjacent lens mounting face of a lens block supported on the lens block support and a retracted position clear of the lens blank and the transporter. The controller communicates with the nozzle manipulator to control deployment and retraction of the nozzle.

The apparatus may include a lens orientation indicator having a first image generator for generating a desired lens orientation image and a second image generator for generating a second image indicating actual orientation of the lens blank. An image comparator communicates with the first and second image generators to display the first image relative to the second image to guide manipulation of the lens blank for the actual orientation to correspond to the desired orientation.

The apparatus may further include a probing station on which the lens blank may be placed by the lens transporter. The probing station may include a plurality of lens probing elements for mapping the contour of a first face of the lens blank to determine a first face contour. The controller may communicate with the probing station to receive information on the contour of the first face relative to a first datum. The transporter may be configured to move the lens blank between the lens probing station and the lens blocking station while maintaining the lens blank in the desired orientation. The controller may be configured to cause the transporter to place the lens adjacent the lens block with the first face a predetermined fixed distance apart from the lens mounting face and maintain the fixed distance during a curing cycle of the adhesive. The controller may translate the first face contour information to a second datum associated with the lens block and store the information relative to the second datum. The lens transporter may include a second face position probe for determining the position and curvature of the second face relative to the first face. The second face position probe may also communicate with the controller to provide position information to the controller relative to the first datum which the controller in turn translates to the second datum.

The dispenser nozzle may be mounted on a dispenser arm moveably mounted to a dispenser body. The dispenser may include an arm actuator communicating with the controller for moving the dispenser arm relative to the dispenser body between the deployed and retracted positions. The dispenser arm may fluidly communicate with an adhesive pump which supplies adhesive to the nozzle. The controller may further communicate with a shut-off mechanism associated with the nozzle to control dispensing of the adhesive through the nozzle.

The apparatus may include a UV shield for shielding an operator from UV light when the UV light source is activated.

The UV shield may be mounted to the transporter and connected to a safety sensor which communicates with the transporter to interrupt motion of the transporter when the shield encounters an obstruction.

The safety sensor may further communicate with the controller with the controller causing the motion of the transporter to be interrupted.

An adhesive curable by UV and visible light for use in lens blocking and the use of such an adhesive in lens blocking is also provided. The adhesive comprises:
an organic resin (meth)acrylic-capped prepolymer selected from the group consisting of aliphatic urethanes in an amount of from 49% by mass to 97% by mass;
an adhesion promoter selected from the group consisting of ethylenically-capped phosphoric ester and ethylenically-capped carboxylic ester in an amount of from 0.01% by mass to 10% by mass;
a plastic adherent selected from the group consisting of isobomyl (meth)acrylate in an amount of from 5% by mass to 25% by mass;
a cohesive hardener selected from the group consisting of multi-functional (meth)acrylic-caped diluents in an amount of from 0.1% by mass to 25% by mass;
a diluent selected from the group consisting of (meth)acrylic-capped poly (ethyleneglycol), (meth)acrylic-capped poly(propylene glycol), (meth)acrylic-capped neopentylglycol and (meth)acrylic-capped glycerol in an amount of from 0.001% by mass to 37% by mass;
a primary α-cleavage, unimolecular Norrish type I photoinitiator selected from the group consisting of acyl phosphine oxide derivatives in an amount from 0.1% by mass to 10% by mass; and,
a secondary α-cleavage, unimolecular Norrish type I photoinitiator selected from the group consisting of acetophenone derivatives in an amount of from 0.1% by mass to 10% by mass.

More preferably, the UV/visible curable adhesive consists of;
the aliphatic urethane oligomer known as *Sartomer CN-966J75 in amounts of from 80% by mass to 90% by mass or its equivalent;
the adhesion promoter known as *UCB Chemicals Radeure Ebecryl 170 in amounts of from 1% by mass to 5% by mass or its equivalent;
one of plastic adherent known as *Sartomer SR-506 in amounts of from 19% by mass to 23% by mass or its equivalent;
the hardener known as *Sartomer SR-454 in amounts of from 5% by mass to 20% by mass or its equivalent;
the primary photoinitiator known as BASF TPO in an amount of from 2% by mass to 5% by mass; and,
the secondary photoinitiator known as *Ciba Darocur 1173 in an amount of from 1% by mass to 4% by mass.

*trademarks

### DESCRIPTION OF DRAWINGS

Preferred embodiments of the present invention are described below with reference to the accompanying illustrations in which:

FIG. 1 is a perspective view of an ophthalmic lens blocking apparatus according to the present invention;

FIG. 2 is a section on line 2-2 of FIG. 1;

FIG. 3 is an enlarged perspective view of the portion of FIG. 1 illustrating a lens blank receiving station, a probing station, a blocking station and a transporter;

FIG. 4 is a section on line 4-4 of FIG. 3;

FIG. 5 is a representation of a typical projected image of a lens blank and a computer generated target as would be seen on a computer screen of the lens blocking apparatus;

FIG. 6 is a perspective view of a lens holder;

FIG. 7 is a cross-sectional view along line 7-7 FIG. 6;

FIG. 8 is a cross-sectional view taken along line 8-8 of FIG. 6;

FIG. 9 is a perspective view of a lens holder similar to FIG. 6 but including a second face position probe mounted atop thereof;

FIG. 10 is a section on line 10-10 of FIG. 3;

FIG. 11 is an elevational view of an array of gauge plungers associated with the probing station;

FIG. 12 is an enlarged partial cross-sectional view of a gauge plunger;

FIG. 13 is a partially cut away perspective view illustrating a lens being held over a lens block by a lens transporter;

FIG. 14 is a partially cut away perspective view illustrating lens placement on a lens block and also illustrating an adhesive dispenser in a retracted position;

FIG. 15 is a partially cut away perspective view illustrating a lens transporter before picking up a lens blank and illustrating an adhesive dispenser in its deployed position; and,

FIG. 16 is a sectional view on line 16-16 of FIG. 14.

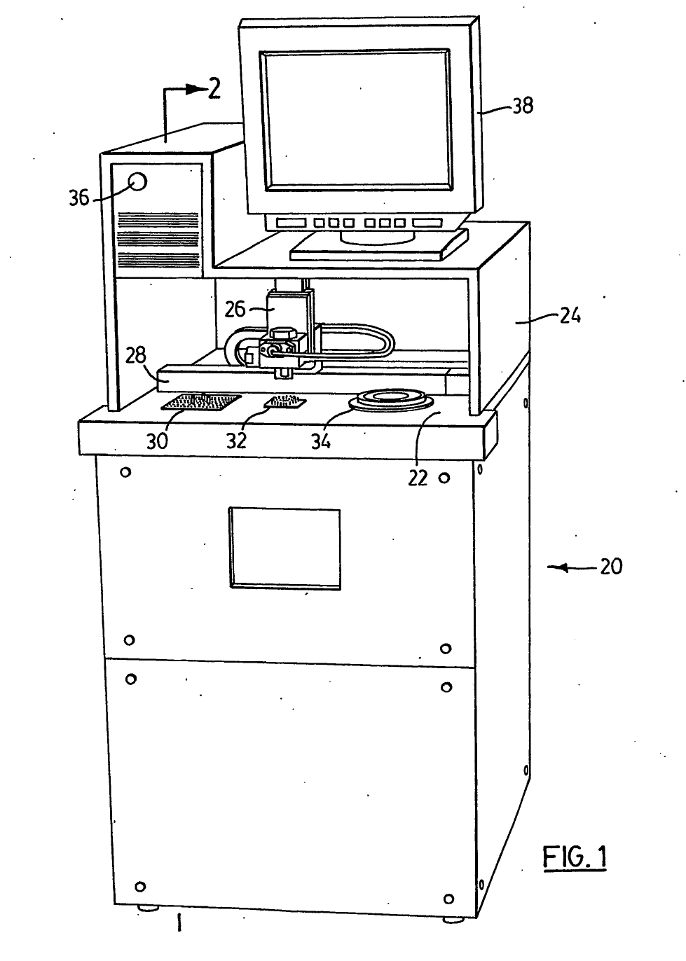

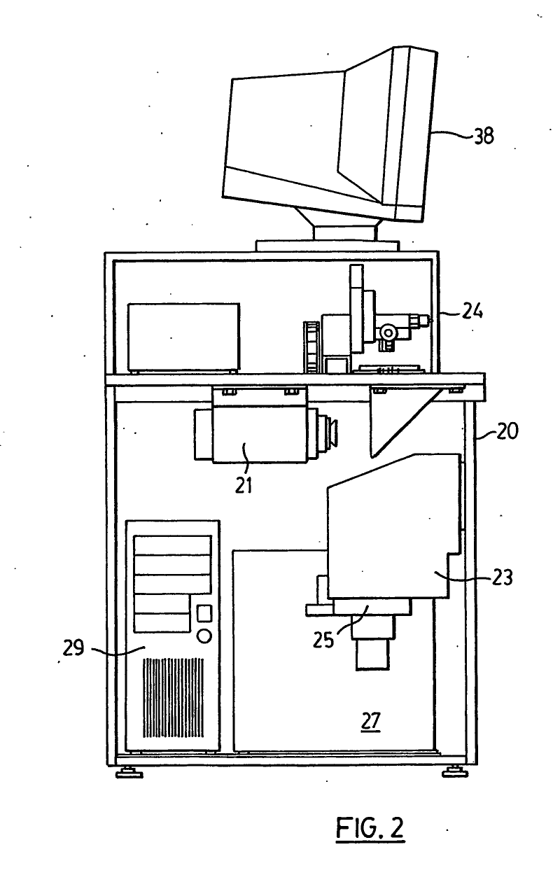

### DESCRIPTION OF PREFERRED EMBODIMENTS

An apparatus for blocking an ophthalmic lens according to the present invention is generally indicated by reference 20 in the accompanying illustrations. The apparatus 20 includes a cabinet having a top 22 and a hood structure 24 for partially enclosing the top 22. A lens transporter 26 is moveably mounted on a first linear actuator 28 affixed to the top 22. The first linear actuator 28 has a first servo motor or stepper motor unit for moving the lens transporter therealong and for monitoring its position.

The apparatus 20 has, aligned with the first linear actuator 28 and incorporated into the top 22 of the cabinet, a first station 30, a probing station 32 and a lens blocking station 34. The apparatus 20 encloses a camera 21 focused on the first station 30, an adhesive reservoir 23 and a pumping unit 25 for pumping the adhesive to the blocking station 34. The apparatus further includes a controller in the form of a central processing unit 29 for controlling its operation.

The first station 30 is utilized for lens orientation to ensure that a lens blank 60 is property aligned and oriented at the outset of the lens blocking process. The imaging station has a ground glass plate 40 with three pegs 42 protruding therefrom in a triangular arrangement. The ground glass plate 40 is mounted over an opening 44 in the top 22 of the apparatus. The camera 21 is mounted under the top 22 and is oriented toward a mirror 48 on a mirror support structure 50 such that a line of sight 52 of the camera is reflected to make a right angle with the ground glass plate 40.

A light (not shown) may be shone through the lens blank 60. The camera communicates with the controller 29 to provide lens orientation information to the controller 29. The controller 29 in turn communicates with a screen 38 and includes a first image generator for generating a desired lens orientation image on the screen 38 and a second image generator which receives information from the camera 21 and generates a second image on the screen 38 indicating actual orientation of the lens blank. The desired orientation will be a predetermined orientation taking into account the shape of the particular lens blank 60 selected and how such a lens blank should be oriented during a lens generation process.

The screen acts as an image comparator and displays the first and second images relative to each other to guide manipulation of the lens blank for orienting the lens blank to correspond to the desired orientation.

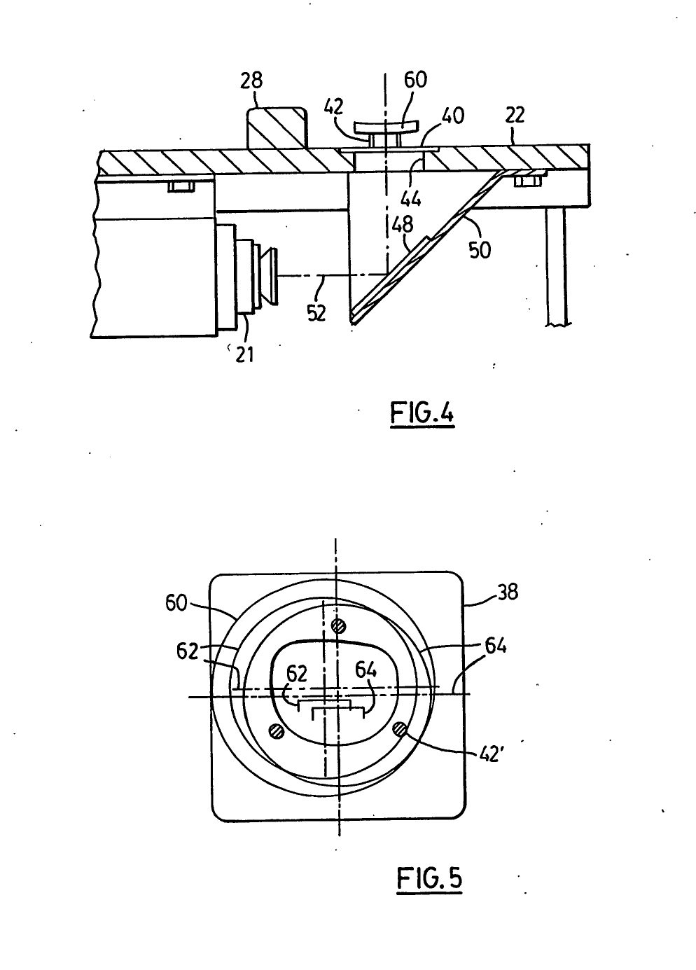

In use, the lens blank 60 is manually placed on the three pegs 42. The image of the lens blank 60 as seen by the camera 21 through the ground glass plate 40 is displayed on the screen 38 and would correspond to the image 60 in FIG. 5. A typical lens blank has manufacturer's markings for orientation purposes and those manufacturer's markings are indicated by reference 62 in FIG. 5. The markings of the computer generated first or target image of the lens are indicated by reference 64. The markings 62 and 64 typically include a circle around a region of the lens blank having the required optical characteristics, a pair of dashed lines showing the lens geometric center and cylindrical axis, and a rectangular symbol indicating the location of a bifocal segment (if any). The computer generated markings 64 may also contain a contour line showing an outline of an eyeglass frame to which the lens is to be mounted.

An operator of the apparatus 20 would move the lens to cause the image of the markings 62 to align with the image of the markings indicating the desired orientation 64. When proper positioning of the lens blank 60 has been effected, the operator may request the controller to register a first position and angular alignment of the lens blank 60 within a horizontal plane, hereinafter referred to as the X-Y plane.

Depending on the lens surfacing equipment utilized, the precision of lens placement may be less critical than the knowledge as to lens parameters, such as the location of a cylindrical axis and the location of a bifocal segment. It may be possible with some lens surfacing equipment to suitably position the lens without a specific predetermined relationship between the lens and a lens blank.

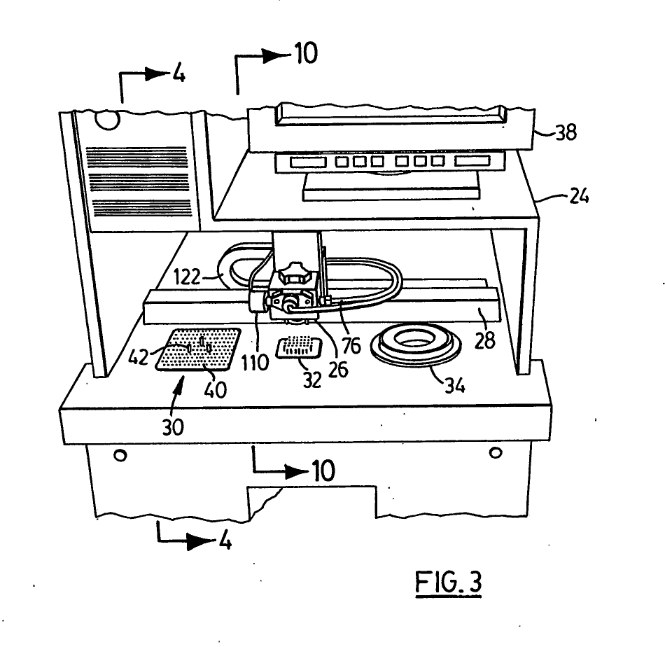

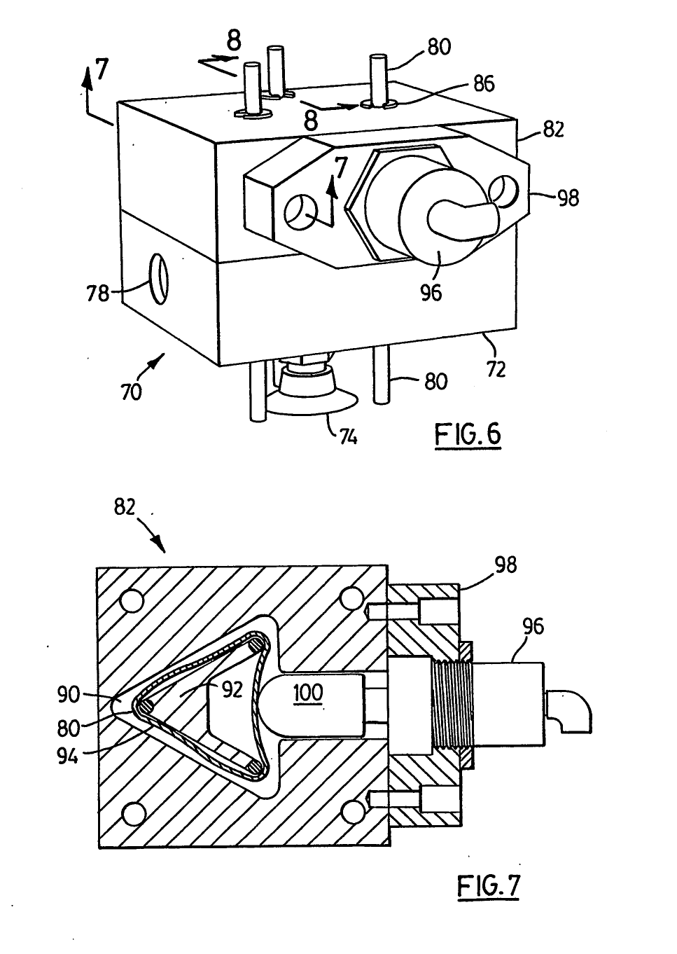

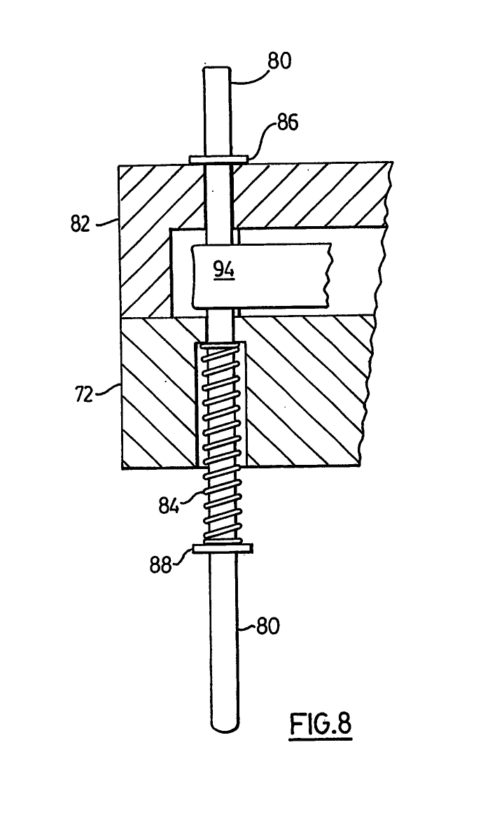

Once orientation and positional parameters of the lens blank 60 have been determined, the lens blank is transported by the transporter 26 from the first station 30 to the probing station 32. The transporter 26 may include a lens holder 70 as illustrated in FIGS. 6 through 8. The lens holder 70 has a manifold block 72 and a vacuum cup 74 connected to a first opening (not shown) through an undersurface of the manifold block 72. A vacuum source and tubing generally illustrated by reference 76 in FIG. 3 is connected to a second opening in a manifold block and in turn communicates with the first opening. The manifold block 72 further has a third opening 78 communicating with the first opening. The lens holder 70 further comprises three prop stems 80 moveably extending in parallel alignment with a central axis of the vacuum cup 74 in a triangular arrangement around the vacuum cup 72. The lens holder 70 further has a prop stem locking mechanism 82 amounted atop the manifold block 72.

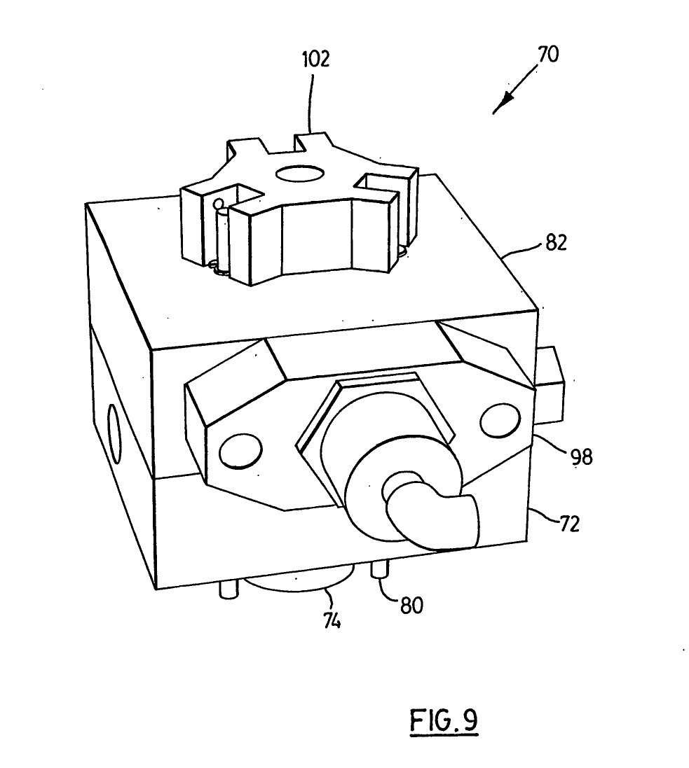

The prop stems 80 extend through the prop stem blocking mechanism 82 and through the manifold block 72 as illustrated in FIG. 8. Each prop stem 80 is urged downward relative to the lens holder 70 by a spring 84 mounted over the prop stem 80. Each spring 84 is seated in a respective recess in the manifold block 72. Each prop stem 80 is held in a respective hold through the prop stem locking mechanism 82 and through the manifold block 72 by means of a first lock washer 86 mounted on the upper end of the prop stem 80 and a second lock washer 88 mounted on the prop stem 80 below the spring 84.

The prop stem locking mechanism 82 includes a module made of rigid material and having a triangular cavity 90 formed therein. The triangular cavity 90 encloses an A-shaped protrusion 92 extending from a bottom surface of the cavity 90 and having a thickness similar to the depth of the cavity. The A-shaped protrusion 92 and the triangular cavity 90 are concentric with one another and are positioned such that each of the three extremities of the A-shaped protrusion 92 is contiguous with a surface along one of the prop stems 80. The prop stem locking mechanism 82 further has in the triangular cavity 90, a flat belt 94 enclosing the A-shaped protrusion and the three prop stems 80.

A pneumatic cylinder 96 is affixed to the side of the prop stem locking mechanism 82 by a collar 98 and fasteners (not shown) through the collar 98 and threaded into the rigid module of the mechanism 82. The pneumatic cylinder 96 has an operable plunger 100 extending into the base of the A-shaped protrusion 92. Extension of the plunger 100 pushes upon the flat belt 94 and stretches the flat belt 94 around the three prop stems 80. The tension in the flat belt 94 causes each prop stem 80 to be pulled and held tightly against a respective extremity of the A-shaped protrusion 92.

The action of the pneumatic cylinder 96 is controlled by the controller 29 in response to a vacuum sensor switch 110 which is illustrated in FIGS. 3 and 10. The vacuum sensor switch 110 is connected to the third opening 78 and monitors the vacuum level in the vacuum cup supply port. In operation, the vacuum cup 74 is lowered on a lens blank 60 and the vacuum cup 74 and the prop stems 80 are brought into contact with the lens blank 60. The vacuum level in the vacuum cup supply port increases in response to the cup being sealed by the lens blank 60 which causes the vacuum sensor switch 110 to send a signal to the controller 29 which in turn activates the pneumatic cylinder 96 for locking the position of the prop stems 80. The lens blank is thereby rigidly retained in the vacuum cup 74.

The raising and lowering movements of the vacuum pick-up device are effected by a second linear actuator 112, also shown in FIG. 10. The movements of the second linear actuator 112 are controlled by a second servo motor or a second motor/encoder unit 114 such that after an initial calibration, a position of the vacuum cup 74 is always known precisely. When the lens holder 70 picks up the lens blank 60 from the first station 30, the controller reads the vacuum sensor switch 110 and the signal of the second motor/encoder unit 114 and registers a first vertical position of a concave surface of the lens blank 60 relative to a vertical axis, hereinafter referred to as the Z axis.

Although vacuum cups in general are known to be somewhat flexible, the locked in place prop stems 80 ensure that the first vertical position registered by the controller 29 is maintained throughout the remaining functions of the apparatus 20.

It will be appreciated that other suitable pick-up devices and control systems for such devices may be devised which would function adequately well in the apparatus 20. For example the vacuum cup might include a rod-like probe mounted centrally therein and a proximity or optical switch for monitoring of the probe rather than a vacuum switch. Also a collet type clamping arrangement of the prop stems 80 may be practised.

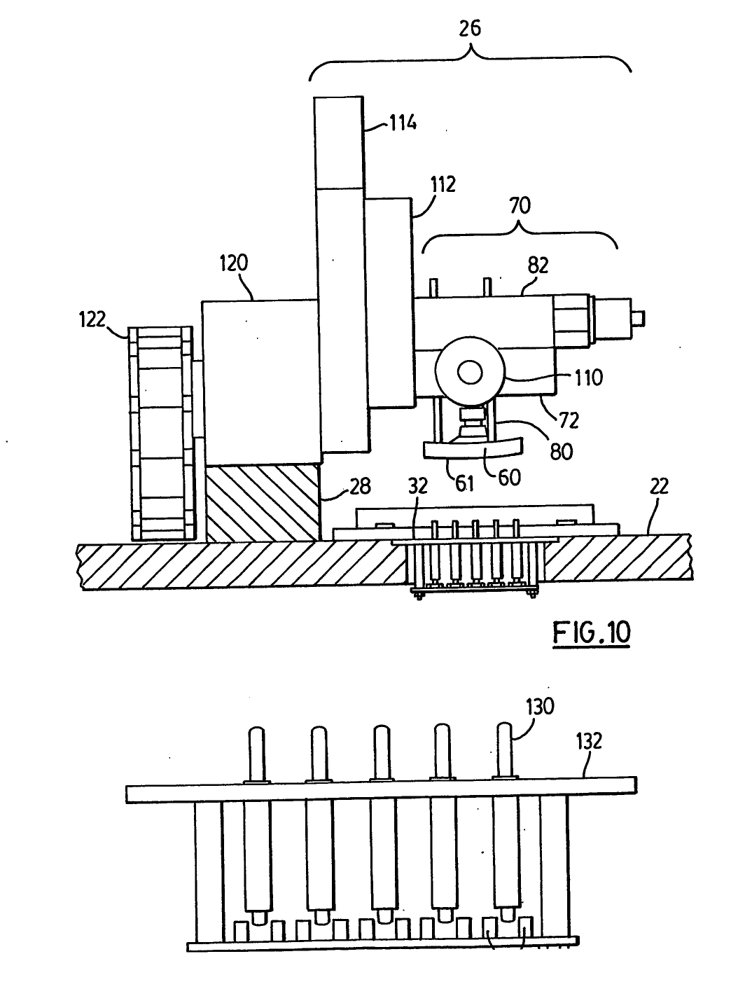

The lens holder 70 preferably has an electronic module 102 containing photoelectric switches for monitoring movement of the prop stems 80. The electronic module 102 acts as a second face position probe for determining the position of an upper or second face of the lens blank 60. The electronic module 102 is preferably mounted atop the prop stem locking mechanism 82. As illustrated in FIG. 9, signals from the electronic module 102, the vacuum sensor switch 110 and the second motor/encoder unit 114 when the vacuum pick-up device is brought in contact with the second surface of the lens blank 60 are integrable for determining or verifying the position of the second face 60.

As illustrated in FIG. 10, the lens transporter 26 is mounted on a carrier block 120 affixed to the moveable member (not shown) of the first linear actuator 28. The control wiring between the controller 29 and the lens blank manipulator 26 is preferably mounted over a flexible cable tray 122 affixed to the top surface 22 of the apparatus 20 and to the carrier block 120.

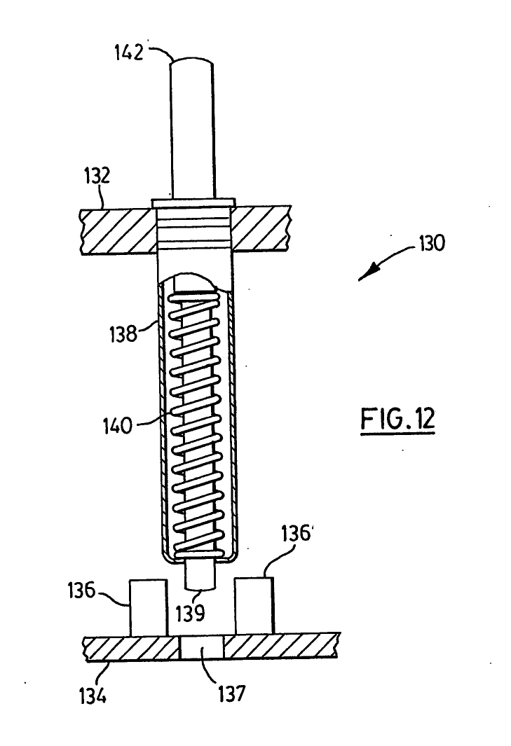

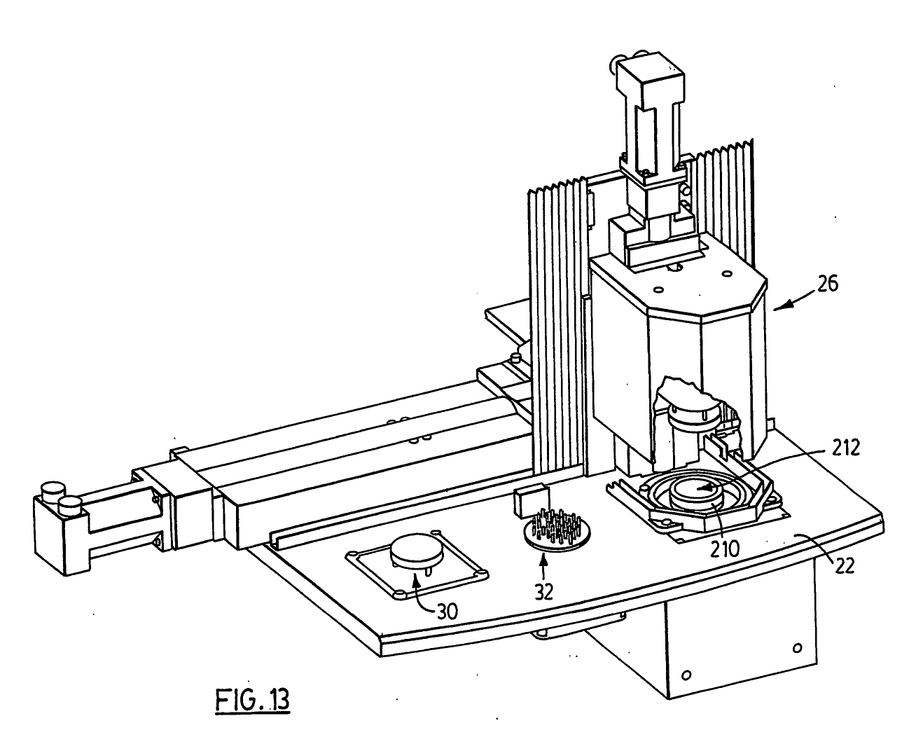

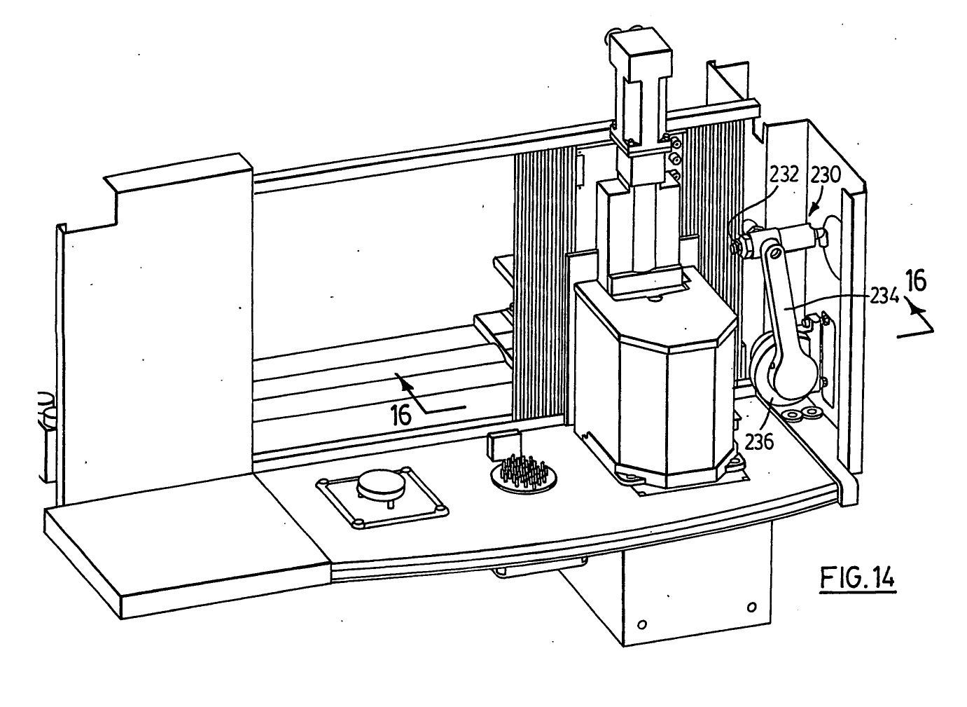

Once the lens blank 60 is held by the lens holder 70 the lens blank 60 is transported from the first station 30 to the probing station 32. The structural details of the probing station 32 are illustrated in FIGS. 11 and 12.

The probing station 32 has a rectangular array of gauge plungers 130 protruding upwardly through a cover plate 132. The gauge plungers 130 extend under the cover plate 132 and near a circuit board 134 affixed at a distance from the cover plate. The circuit board 134 has a plurality of photoelectric switches each comprising a photoelectric emitter 136 and a photoelectric receiver 136′. Each photoelectric switch 136-136′ is positioned in close proximity to the lower end of the plunger 130 for monitoring a downward displacement of that plunger 130.

Each gauge plunger 130 comprises a tubular housing 138 which is affixed to the cover plate 132. A rod 139 is moveably mounted in the housing 138 and is urged upwardly by a spring 140. Each rod 139 has a rounded tip 142 extending above the cover plate 132. The circuit board 134 further has a hole 137 between each emitter 136 and receiver 136 for allowing a downward movement of each rod 139 through the circuit board 134 when the rounded tip 142 is depressed.

When the lens blank 60 is lowered on the probing station with a convex surface (“first face” 61) of the lens blank 60 contacting the tips 142 of the gauge plungers 130, the controller 29 reads the encoder of the second stepper motor/encoder unit 114 and the signal from each photoelectric switch 136-136′. The controller 29 integrates the signals of the encoder and switches 136-136′ to determine the curvature of the first face 61 and a position of this curvature along the Z axis.

Once the first face 61 of the lens blank 60 has been probed, the lens blank is transported from the probing station 32 to the blocking station 34. The blocking station includes a UV and visible light transmissive lens block support 200 for receiving and supporting a lens block 210 with a lens mounting face 212 of the lens block facing upwardly. The lens block should be of a transparent material capable of transmitting at least light in the UV spectrum and preferably also in the visible spectrum.

A UV light source 220 is associated with the lens block support in that it is mounted so as to direct light through an aperture 202 in the lens block support which in turn directs the UV light through the UV transmissive lens block 210. A light source actuator which may form part of the controller 29 is connected to the light source to control activation and de-activation of the light source 220.

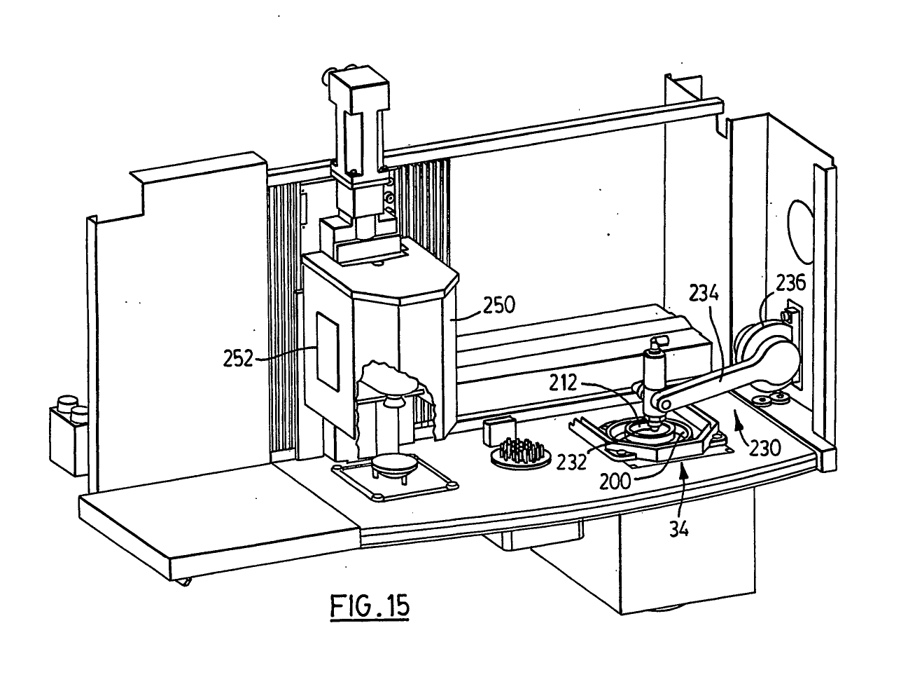

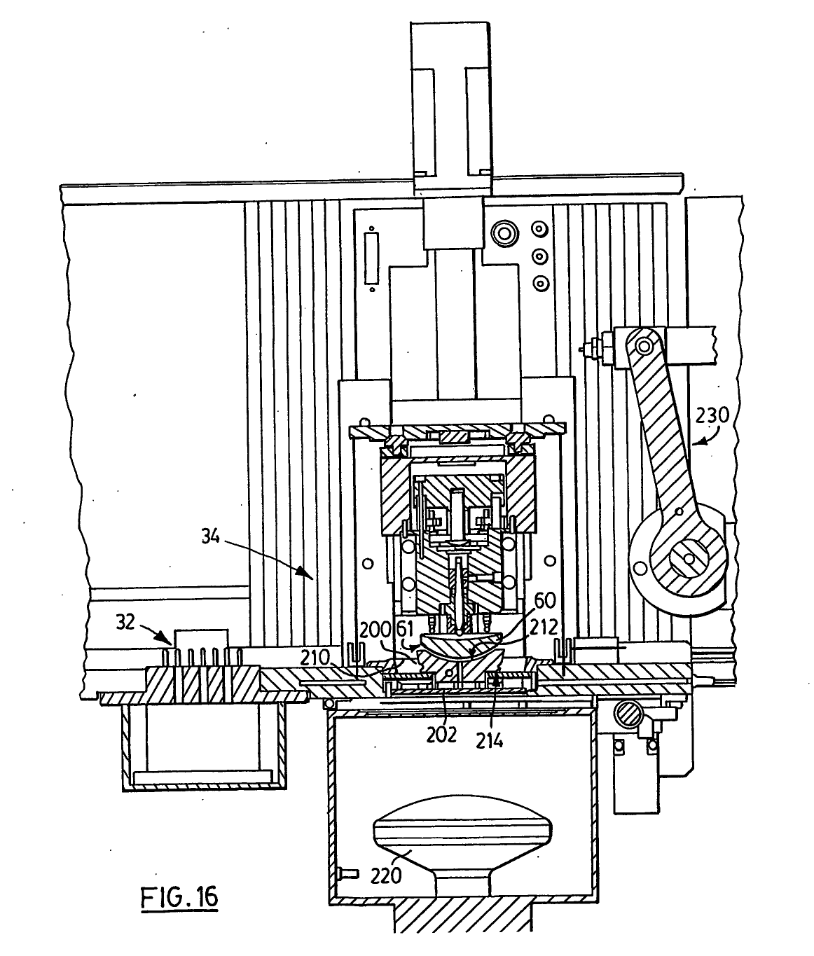

A dispenser 234 for dispensing an adhesive curable by UV/visible light is generally indicated by reference 230. The dispenser 230 has a dispenser nozzle 232 at one end of a dispenser arm 234. An arm actuator which may be a motor such as illustrated by reference 236 or a linear or other actuator may be provided to move the arm 234 from a deployed position adjacent the lens mounting face 212 (FIG. 15) and a retracted position clear of the lens mounting face 212 (FIG. 14) and the lens transporter 26 so as not to interfere with the placement of the lens over the lens mounting face 212 of the lens block 210.

The dispenser arm 234 merely controls position of the dispenser nozzle 232. Accordingly the dispenser arm 234 can be telescopic rather than rotatable as illustrated and possibly controlled by a linear actuator such as a fluid pressure actuated piston within a cylinder.

The nozzle 232 fluidly communicates with the adhesive reservoir 23 through the pump 25 which supplies the adhesive to the nozzle 232. Alternatively, the adhesive reservoir 23 may be pressurized thereby obviating the need for a pump.

The nozzle 232 is equipped with a valve or other shut-off mechanism which communicates with the controller 29 to control dispensing of the adhesive through the nozzle 232 when the nozzle is in the deployed position. Different control arrangements may be used. A simple form of control is to monitor the time that the nozzle 232 is held open. Other controls such as a metering pump may be utilized. Generally whatever control is selected should dispense a measured amount of adhesive which will substantially fill the gap between the first face of the lens blank 60 and the lens mounting face 212 of the lens block 210.

The UV light source 220 preferably incorporates a flash lamp such as manufactured by Xenon Corporation which emits a pulse of high intensity short duration light within the UV spectrum and in the visible spectrum. An example of this light source 220 is Xenon Model RC-742 with a flat spiral 4.2″ lamp or a 3.5″ flat spiral xenon gas-filled, gallium-doped clear fused quartz lamp. A single or a double-headed system is suitable. With the double-headed system, a common power supply may be shared between the blocking and the wiring functions. One embodiment of this apparatus is described in U.S. Pat. No. 4,167,669, which is herein incorporated by reference. The wavelength of the light should be on the order of 250 to 500 nanometers. In practice it has been found that the shorter wavelength light contributes to the speed of curing while the longer wavelength effects a better depth of cure.

The Xenon light generates a nominal amount of heat which is desirable from an equipment standpoint as compared with a mercury vapor lamp. The range of wavelengths is broader and more selectable than with a conventional mercury-based UV lamp and furthermore the Xenon bulbs tend to last much longer than mercury-based UV lamps.

Flash lamp technology is able to produce very high peak power, in the order of 2.7 megawatts. Fusion UV microwave-activated mercury and metal halide lamps produce a continuous 1.8 kilowatts power output—over 1,000 times less. This high peak power enables light to penetrate over long distances or even through UV opaque materials. In the present application, high output power is used to speed cure and penetrate the lens block 210.

A further advantage to the flash lamp is through the use of gallium-doped quartz enveloping Xenon gas in the lamp, ozone gas is not produced. This makes the apparatus safer, less hazardous, easier to engineer, less expensive to manufacture and easier/more economical to maintain as it does not require exhausting ozone gas to the atmosphere. Ozone gas production is a by-product of mercury discharge lamps.

Additionally, the wavelength/intensity graph for a Xenon flash lamp is devoid of wavelength spikes—intensity being smooth and continuous over the UV-C, UV-B, UV-A and visible wavelengths. This simplifies and opens up photoinitiation formulation possibilities in the adhesive as the wavelength absorptions of the photoinitiator are not critical to the efficiency of the curing process. Mercury discharge lamps in contrast have defined intensity spikes at specific wavelengths. In these systems, photoinitiators must overlap with these wavelength spikes or the material will not cure. Non-efficient and deficient wavelength overlap between a mercury lamp and photoinitiator also retards the rate of cure—the lamp output only covers a range what the photoinitiator could absorb.

Another advantage to a Xenon flash lamp is instant on/off capability. This is not possible with mercury or metal halide lamps and simplifies the design, manufacture, operation and safety aspects of the blocking apparatus of the present invention.

Also, the geometry of Xenon flash lamps is virtually unlimited. Good results have been obtained with spiral lamps of about 3.5 inches diameter which conforms to typical circular lens blanks which may vary from 3 inches to 3.5 inches in diameter. In contrast fusion UV lamps are restricted to linear format because of the type of lamp and because of the restrictions of microwave-actuated ignition.

In order to protect an operator's eyes from damage associated with the intense UV light, a UV shield 250 may be provided over the lens transporter which registers with the lens block support 200 during the final stages of blocking. The UV shield may also be associated with a safety sensor schematically shown at 252 in FIG. 15 which causes the transporter 26 to stop if the sensor 252 senses an object in the path of the transporter 26.

In use, a measured amount of UV curable adhesive is dispensed on the lens mounting face 212 of the lens block 210. The lens blank 60 is moved over the lens bock 210 with the first face 61 of lens blank facing the mounting face 212. The lens transporter 26 moves the lens blank 210 toward to the lens mounting face 212 and into the adhesive 242 until the first face 61 is a predetermined distance from the lens mounting face 212.

Because the geometry and spatial relationships between the first face 61 and the lens mounting face 212 are known, the amount of adhesive required can be calculated and dispenses automatically without operator intervention. Many prior processes require an operator to monitor and control the application of the bonding agent.

At this stage, UV light is generated and transmitted through the lens block 210 at a wavelength, and intensity and for a duration sufficient to cause the adhesive to cure thereby bonding the lens blank 60 to the lens block 210.

The lens block 210 has an indexing face 214, which during lens generation would typically abut against a lens chuck. The controller 29 determines the height of the lens blank 60 above the indexing face 214 and references the first face surface contour data to a datum associated with the indexing face 214 and records the reference to data. In this manner, the curvature and position of the first face 61 of the lens 60 can be determined in subsequent lens generation steps based on the position of the datum. Although an indexing face 214 is suggested, it will be appreciated that other parts of the lens block 210 may be relied upon as a reference datum.

As a final step, the lens block 210 with the lens 60 attached thereto would be removed from the blocking station 34 and released from the lens transporter 26.

Although the term “adhesive” is used herein, it will be appreciated that the adhesive properties are initiated by the exposure to radiation and the standing composition may be more of a “coating composition” than an adhesive prior to such irradiation.

Various properties are desirable in the coating composition. The coating composition should have a viscosity sufficient to avoid spillage into the lens block support 200 without being so high as to be time consuming to dispense and expensive to manipulate. The viscosity should be almost gel-like but dispensable without specialized equipment. A viscosity on the order of 50,000 cps is preferred.

The dimensional change of the coating composition upon curing is an important factor. Too great a change will cause lens deformation during lens generation by imparting too high a stress on the lens blank 60. A high dimensional change can be ameliorated to some extent by a longer curing time, however this is undesirable. Preferably the curing time should be less than 30 seconds and more preferably less than 15 seconds, and still more preferably on the order of 5 to 10 seconds.

The flexibility of the cured coating composition is also an important factor. From a machining standpoint the adhesive should be as hard as possible to provide as much support as possible to the lens 60 during generation. If however the adhesive is too hard, vibration and forces associated with the lens generation process may have the effect of prematurely de-blocking the lens. Some flexibility is desirable to absorb some of the cutting energy while not so much flexibility as to provide undesirable deflections in response to the application of a cutting tool. Furthermore, it has been found that harder adhesives tend to have lower adhesions.

The adhesive should be such as to be removable without damage or residue. In other words, the adhesive must be capable of total adhesive failure upon requirement. In order to expedite de-blocking by minimizing the time for de-blocking, a mechanically de-blockable adhesive is preferred over one which requires prolonged soaking as part of-the de-blocking procedure.

Furthermore, the adhesive is preferably of at least a quasi-thermosetting nature in that in will not deform under heat which may be imparted to the lens in curing coating compositions and through friction generated by the lens surfacing procedure.

In one embodiment, the coating composition comprises a radiation curable organic resin, an adhesives promoter and a cohesive hardener if the composition is intended to be cured by ultraviolet radiation, the composition includes a photoinitiator.

It has been found that a particularly useful coating composition may be produced by combining:
an organic resin (meth)acrylic-capped prepolymer selected from the group consisting of aliphatic urethanes in an amount of from 49% by mass to 97% by mass;
an adhesion promoter selected from the group consisting of ethylenically-capped phosphoric ester and ethylenically-capped carboxylic ester in an amount of from 0.01% by mass to 10% by mass;
a plastic adherent selected from the group consisting of isobomyl (meth)acrylate in an amount of from 5% by mass to 25% by mass;
a cohesive hardener selected from the group consisting of multi-functional (meth)acrylic-caped diluents in an amount of from 0.1% by mass to 25% by mass;
a diluent selected from the group consisting of (meth)acrylic-capped poly (ethyleneglycol), (meth) acrylic-capped poly (propylene glycol), (meth)acrylic-capped neopentylglycol and (meth)acrylic-capped glycerol in an amount of from 0.001% by mass to 37% by mass;
a primary α-cleavage, unimolecular Norrish type I photoinitiator selected from the group consisting of acyl phosphine oxide derivatives in an amount from 0.1% by mass to 10% by mass; and,
a secondary α-cleavage, unimolecular Norrish type I photoinitiator selected from the group consisting of acetophenone derivatives in an amount of from 0.1% by mass to 10% by mass.

In principle, the organic resin may be curable by light, electron beam, or thermally. In one embodiment, the organic resin is able to be cured by light radiation, such as ultraviolet light or high frequency visible light.

The organic resin may be at least one of or a combination of an aliphatic urethane, an aromatic urethane, a polyester, a polyether or an epoxy. In one embodiment, the organic resin is a mono-, or multi-functional ethylenically-capped prepolymer. The prepolymer may include any one of an aliphatic urethane, aromatic urethane, polyester, polyether or epoxy backbone. In another embodiment, the resin in an aliphatic urethane oligomer, such as a di-functional acrylate-capped aliphatic urethane oligomer.

In another embodiment, the organic resin may be a difunctional (meth)acrylic-capped prepolymer selected from the following sources: Akzo Nobel Actilane 200 series; Rahn Genomer 4000 series; Henkel Cognis Photomer 6000 series; Sartomer CN-900 series; Bomar Specialties BR-300/BR400/BR-500/BR-700 and BR-900 series; UCB Chemicals Radcure Ebecryl series or their equivalents.

The adhesion promoter may be a composition that may or may not be radiation-curable that has the property of enhancing adhesion to plastic materials that has used for the purposes of an ophthalmic lens. The adhesion promoter may be an electrophilic, electron deficient substance such a trivalent boron or aluminum compound, for example, boron trifluoride or aluminum trichloride. In another embodiment, the adhesion promotor is an acidic substance that would be able to dissociate in an aqueous solution or water to yield hydrated protons such as an organic or inorganic acid, for example carboxylic acids, phosphoric acid or sulfuric acid. This molecule or combinations of molecules may or may not be radiation-curable yet all possess the property of enhancing adhesion to plastic materials that are used for the purposes of an ophthalmic lens.

In one embodiment, the adhesion promoter is a mono-or di-functional ethylenically-capped phosphoric acid ester or ether or an ethylenically-functionalized carboxylic acid where the ethylenic group may comprise a vinyl ether, (meth)acrylate ester, (meth)acrylic acid or any other ethylenic function that has the ability to crosslink under the action of radiation of an appropriate wavelength. A suitable adhesion promoter has been found to be the diacrylate ester of phosphoric acid (Ebecryl 170). Other suitable adhesion promoters may be selected from the following sources: Rahn Additive 97-070; Henkel Cognis Photomer 4173; UCB Chemicals Radcure Ebecryl 170; UCB Chemicals Radcure Ebecryl 168; UCB Chemicals Radcure β-CEA or their equivalents.

The plastic adherent may be any molecule, that may or may not be radiation-curable, that has the property of adhesion to plastic materials, such as thermoplastic polycarbonate, thermosetting polycarbonate, polyurethane, or any plastic material that is used for the purposes of an ophthalmic lens. In one embodiment, the plastic adherent includes isobomyl acrylate, isobornyl methacrylate, or tetrahydrofuryl acrylate. A suitable plastic adherent may be selected from the following sources: Sartomer SR-506; Sartomer SR-423; UCB Chemicals Radcure IBOA; Rahn Genomer 1121; Ciba Ageflex IBOMA; Ciba Ageflex IBOA or their equivalents.

The hardener may be any molecule which may or may not be radiation-curable that has the property of increasing the cohesive strength of the radiation-curable material. In one embodiment, the hardener is a multifunctional ethylenically-capped monomer or oligomer with at least three functional groups. The hardener may be triacrylate, tris (2-hydroxyethyl) isocyanuarate triacrylate, dipentaerythritol pentaacrylate, pentaeyrritol tetrascrylate, ethoxylated (4) pentaerythritol tetraacrylate, ethoxylated (3) trimethylolpropane triacrylate, ethyloxylated (6) trimethylolpropane triacrylate, or ethyloxylated (9) trimethylolpropane triacrylate. A suitable hardener may be a tri-, tetra-, penta-, or hexa-functional cohesive hardener selected from the following sources: Sartomer-SR-351, SR-368, SR-368D, SR-399, SR454, SR-499, SR-502, Henkel Cognis Photomer 4006 or their equivalents.

Suitable photoinitiators include acetopherone derivatives, such as Benzildimethylketal/1-Hydroxycyclohexylphenylketone/2-hydroxy-2-methyl-1-phenylpropan-1-one (Ciba Darocur 1173). Suitable photoinitiators also include acyl phosphine oxides such as: 2,4,6-trimethylbenzoyldiphenylphosphine oxide (BASF TPO)/Bis(2,6-dimethoxybenzoyl)-2,4,4-trimethylpentylphosphine oxide/Bis(2,4,6-trimethylbenzoyl)phenylphosphine oxide. One suitable photoinitiator is a photoinitiator that can undergo Norrish-type 1 cleavage.

In one embodiment, the photoinitiator includes a primary photoinitiator and a secondary photoinitiator. Where primary and secondary photoinitiators are used, the primary and secondary photoinitiators may be any molecule or combination of molecules that possesses a broad range of wavelength absorptions in the ultra-violet and visible regions of the electromagnetic spectrum that causes the molecule or molecules to undergo unimolecular Norrish-type I cleavage thereby decomposing into fragments that catalyze the polymerization of the radiation-curable adhesive.

The primary photoinitiator may be a primary acyl phosphine oxide derivative photoinitiator selected from the following sources: Ciba Specialty Chemicals; ChemFirst Fine Chemicals; BASF; Rahn; Spectra Group Ltd., Inc.,; Cognis Corporation; Miwon Commercial Co., Ltd.; Dow Chemicals or their equivalents.

The secondary photoinitiator may be a secondary acetophenone derivative photoinitiator selected from the following sources: Ciba Specialty Chemicals; ChemFirst Find Chemicals; BASF; Rahn; Spectra Group Ltd., Inc.; Cognis Corporation, Miwon Commercial Co., Ltd.; Dow Chemicals or their equivalents.

In one embodiment, the coating composition is characterized by a hardness value or property from about 47 A to about 98 A. In a preferred embodiment, the hardness value is greater than about 75 A. Significant enhancement of optical accuracy for generated plastic ophthalmic lenses was observed for radiation-curable materials for hardness values above 75 A. Even more preferably, the hardness value is greater than about 88 A. Hardness values were measured using a durometer and, in particular, a Rex Durometer Type A Model 1700 from Rex Guage Co., Glenview, Ill., U.S.A. As a point of reference, 0 A=56 grams deflection load and 100 A=822 grams deflection load. It is a linear calibration curve between these two points.

An example of a method used to measure hardness will now be explained. A quantity of radiation-curable material was placed between a block and a lens and exposed to ultraviolet and visible radiation such that crosslinking was complete. The resultant 1 mm thick disc was cut into six substantially equal areas and stacked to yield a 6 mm stack of cured material supported on a bench. The Rex Durometer Type A Model 1700, as described above, was then pressed into the stack and the hardness value observed on an integral dial guage was recorded. The test was repeated at least four times and the mode, or most frequently observed value, was taken as the true hardness of the material.

In one embodiment, the coating composition is characterized by a viscosity within the range of from about 10,000 CP to about 70,000 CP, where the viscosity values are referenced to 25° C.

In one embodiment, the coating composition comprises:
the aliphatic urethane oligomer known as *Sartomer CN-966J75 in amounts of from 80% by mass to 90% by mass or its equivalent;
the adhesion promoter known as *UCB Chemicals Radcure Ebecryl 170 in amounts of from 1% by mass to 5% by mass or its equivalent;
one of plastic adherent known as *Sartomer SR-506 in amounts of from 19% by mass to 23% by mass or its equivalent;
the hardener known as *Sartomer SR-454 in amounts of from 5% by mass to 20% by mass or its equivalent;
the primary photoinitiator known as BASF TPO in an amount of from 2% by mass to 5% by mass; and,
the secondary photoinitiator known as *Ciba Darocur 1173 in an amount of from 1% by mass to 4% by mass.

A suitable coating composition based on the above criteria is as follows:
the aliphatic urethane oligomer known as *Sartomer CN-966J75 in an amount of 85% by mass;
the adhesion promoter known as *UCB Chemicals Radcure Ebecryl 170 in an amount of 1% by mass;
the hardener known as *Sartomer SR-454 in amounts of 8% by mass;
the primary photoinitiator known as BASF TPO in an amount of 2% by mass; and
the secondary photoinitiator known as *Ciba Darocur 1173 in an amount of 3% by mass.

The hardness of this formulation, measured as described above was 88 A. The viscosity was 50,000 CP, referenced to 25° C.

*trademarks

The above description describes an apparatus in which the lens block is placed in the support and adhesive is subsequently applied to the lens block. Other arrangements are feasible. For example, the adhesive may be applied to the lens block in advance of the lens block being mounted in the support or the adhesive may be supplied to the lens rather than the lens block Furthermore, it may be possible to effect relative movement of the lens blank and lens block toward each other by moving both or by holding one stationary and moving the other. Accordingly the expansion, “urging the lens blank toward the lens block” should be given such a broad interpretation. As a practical matter it is generally expected that the lens block will be placed with the lens mounting surface facing upwardly and the adhesive subsequently applied While this may be a preference, it is not an absolute requirement.

The above description is illustrative of a presently preferred embodiment of the present invention. It is not intended in a restrictive sense. Variations may be made without departing from the spirit and scope of the invention as defined by the claims set out below.

1. A method for blocking a lens blank comprising the steps of:
(i) obtaining a lens block which is transmits UV and visible light;
(ii) applying an adhesive curable by at least one of visible and UV light to at least one of a first face of a lens blank and said lens block;
(iii) urging said lens blank toward said lens block with said first face of said lens blank facing said lens mounting face and a second face, opposite said first face facing away from said lens mounting face;
(iv) generating UV and visible light and transmitting the light to said adhesive through said lens block, said light being of a wavelength and an intensity and applied for a time interval sufficient to cause setting of said adhesive.
(v) said adhesive being selected to have a dimensional change upon setting low enough to be capable of setting in less than 30 seconds without imparting undue stresses on said lens blank and capable of total adhesive failure without lens or lens blank damage or leaving residue on said lens upon application of a sufficient stripping force acting between said lens blank and said lens block.

2. The method of claim 1 wherein:
said block is oriented with said mounting face substantially horizontal during steps (ii) , (iii) and (iv); and,
said lens blank is maintained at a predetermined orientation relative to said lens block during steps (iii) and (iv).

3. The method of claim 2 wherein:
the contour of said first face is determined prior to step (iii); and,
said first face is maintained at a predetermined spaced apart distance from said lens mounting face during step (iv).

4. A method for blocking a lens comprising the steps of:
(i) placing a lens blank on a lens orienting station;
(ii) determining lens orientation and position parameters;
(iii) transporting said lens blank to a probing station while maintaining said orientation from step (ii);
(iv) mapping a first face contour of said lens blank while maintaining said orientation and generating and storing surface contour data;
(v) installing a UV and visible light transmissive lens mounting block in a lens blocking station;
(vi) applying an adhesive curable by light within the UV and visible spectrum to at least one of said lens mounting face and said first face;
(vii) transporting said lens blank to said lens blocking station and positioning said lens blank over said lens mounting face with said first face facing said lens mounting face while maintaining said orientation;
(viii) moving said lens blank toward said lens mounting face adhesive until said first face is a predetermined distance from said lens mounting face and said adhesive extends between said lens mounting face and said first face;
(ix) transmitting UV and visible light through said lens block at a wavelength and an intensity and for a duration sufficient to cause said adhesive to cure thereby bonding said lens blank to said lens block;
(x) referencing said first face surface contour data to a datum associated with said lens block and recording the referenced data; and,
(xi) removing said lens block with said lens blank attached thereto from said blocking station.

5. The lens blocking method of claim 4 wherein said lens blank has a second face opposite said first face and including the further steps of:
determining a position of said second face; and,
referencing said position of said second face relative to said datum on said lens block.

6. The lens blocking method of claim 5 wherein said adhesive is selected to:
be of a sufficiently high viscosity to avoid spillage during steps (ix), (x) and (xi);
upon curing provide support to resist lens deflection during lens generation;
absorb vibration imparted to said lens by a lens surfacing tool during said lens generation; and,
be capable of total adhesive failure without lens or lens block damage or leaving residue on said lens upon application of a sufficient stripping force acting between said lens blank and said lens block.

7. The lens blocking method of claim 6 wherein said adhesive is further selected to:
be capable of setting in less than 30 seconds without imparting undue stress on said lens blank; and,
not deform under heat associated with lens coating curing.

8. The method of claim 4 wherein step (ii) comprises the following substeps:
(a) generating a desired lens blank position and orientation image on a screen;
(b) generating an image on the screen depicting the orientation of the lens blank on the lens orienting station; and,
(c) positioning and orienting the lens blank to cause the image in step (b) to correspond to the image in step (a).

9. The method of claim 7 wherein step (ii) is carried out using computer image recognition to generate orientation and position parameters which are stored and form part of the first face surface contour data, which are referenced in step 9.

10. An apparatus for blocking an ophthalmic lens blank comprising;
a lens blank receiving station for receiving said lens blank;
a lens blocking station having a lens block support for receiving a UV and visible light transmissive lens block and supporting said lens block with a lens mounting face of said lens block in a desired orientation, said lens block support being capable of transmitting UV and visible light;
a lens transporter having a lens holder for selectively picking up and holding said lens blank, moving said lens blank-over said lens block support and moving said lens blank toward said lens blank support; and,
a light source associated with said lens block support for emitting UV and visible light and directing said light through said lens block;
a light source actuator connected to said light source for controlling activation and deactivation of said light source;
an adhesive dispenser associated with said lens blocking station for dispensing a UV and visible light curable adhesive for bonding a lens blank on said lens mounting face;
a dispenser actuator connected to said dispenser for causing said dispenser to dispense said adhesive;
a controller communicating with said transporter, said dispenser actuator and said light source actuator to control the operation thereof.

11. An apparatus of claim 10 wherein;
said dispenser includes a dispenser nozzle and a nozzle manipulator connected thereto for moving said nozzle between a deployed position adjacent said lens mounting face of a lens block supported on said lens block support and a retracted position clear of said lens blank and said transporter; and,
said controller further communicates with said nozzle manipulator to control deployment and retraction of said nozzle.

12. The apparatus of claim 11 wherein said first station includes:
a lens orientation indicator having a first image generator for generating a desired lens orientation image and a second image generator for generating a second image indicating actual orientation of said lens blank; and,
an image comparator communicating with said first and second image generators for displaying said first image relative to said second image to guide manipulation of said lens blank to cause said actual orientation to correspond to said desired orientation.

13. The apparatus of claim 12 wherein:
said apparatus further includes a probing station on which said lens blank may be placed by said lens transporter, said probing station includes a plurality of lens probing elements for mapping the contour of a first face of said lens blank to determine a first face contour;
said controller communicates with said probing station to receive information on the contour of said first face relative to a first datum;
said transporter is configured to move said lens blank between said probing station and said blocking station while maintaining said lens blank in said desired orientation;
said controller is configured to cause said transporter to place said lens adjacent said lens block with said first face a predetermined fixed distance apart from said lens mounting face and maintain said fixed distance during curing of said adhesive; and,
said controller translates said first face contour information to a second datum associated with said lens block and stores said information relative to said second datum.

14. The apparatus of claim 13 wherein:
said lens transporter includes a second face position probe for determining the position of said second face relative to said first face and transmits said second face position to said controller.

15. The apparatus of claim 13 wherein:
said dispenser nozzle is mounted on a dispenser arm movably mounted to a dispenser body;
said dispenser includes an arm actuator communicating with said controller for moving said dispenser arm relative to said dispenser body between said deployed and retracted positions;
said nozzle fluidly communicates with a UV curable adhesive source having pressurizing means for supplying said UV curable adhesive to said nozzle;
said controller communicates with a shut-off mechanism associated with said nozzle to control dispensing of said adhesive through said nozzle.

16. The apparatus of claim 14 wherein:
said dispenser nozzle is mounted on a dispenser arm movably mounted to a dispenser body;
said dispenser includes an arm actuator communicating with said controller for moving said dispenser arm relative to said dispenser body between said deployed and retracted positions;
said nozzle fluidly communicates with a UV curable adhesive source through a pump for supplying said adhesive to said nozzle;
said controller communicates with a shut-off mechanism associated with said nozzle to control dispensing of said adhesive through said nozzle.

17. The apparatus of claim 16 wherein:
said apparatus includes a UV shield for shielding an operator from UV light when said UV light source is activated.

18. The apparatus of 17 wherein:
said UV shield is mounted to said transporter; and,
said UV shield is connected to a safety sensor which communicates with said transporter to interrupt motion of said transporter when said shield encounters an obstruction.

19. The apparatus of claim 18 wherein:
said safety sensor communicates with said controller and said controller causes said motion of said transporter to be interrupted.

20. The use in lens blocking of a radiation curable coating composition comprising:
radiation curable organic resin;
an adhesion promoter;
a cohesive hardener; and
a photoinitiator.

21. A radiation curable coating composition comprising:
a radiation curable organic resin;
an adhesion promoter; and
a cohesive hardener.

22. The coating composition as claimed in claim 21, wherein the coating composition is characterized by a hardness value of greater than about 75 A.

23. The coating composition as claimed in claim 22, wherein the coating composition is characterized by a hardener value of greater than about 88 A.

24. The coating composition as claimed in claim 21 wherein the adhesion promoter is an electrophilic, electron deficient compound.

25. The coating composition as claimed in claim 21, wherein the adhesion promoter is an acidic compound that is able to dissociate in an aqueous solution or water to yield hydrated protons.

26. The coating composition as claimed in claim 24, wherein the cohesive hardener is a multi-functional ethylenically-capped monomer or oligomer with at least three functional groups.

27. The coating composition as claimed in claim 26, wherein the hardener is selection from the group consisting of triacrylate, tris (2-hydroxyethyl) isocyanuarate triacrylate, dipentaerythritol pentaacrylate, pentaerythritol tetraacrylate, ethoxylated (4) pentaerythritol tetraacrylate, ethoxylated (3) trimethylolpropane triacrylate, ethyloxylated (6) trimethylolpropane triacrylate, or ethyloxylated (9) trimethylolpropane triacrylate.

28. The coating composition as claimed in claim 27, wherein the radiation curable organic resin is selected from the group consisting of an aliphatic urethane, an aromatic urethane, a polyester, a polyether, or an epoxy.

29. The coating composition as claimed in claim 28, fiber comprising a photoinitiator.

30. The coating composition as claimed in claim 29, wherein this photoinitiator can undergo Norris type-1 cleavage.
